(19) United States
(12) Patent Application Publication
(10) Pub. No.: US 2017/0270466 A1
(43) Pub. Date: Sep. 21, 2017

(54) METHOD AND SYSTEM USING WITH AUTOMATED GUIDED VEHICLE

(71) Applicant: Jusda International Logistics (TAIWAN) CO.,LTD, Taoyuan (TW)

(72) Inventors: CHIA-LIN KAO, New Taipei (TW); FENG-TIEN YU, Taipei City (TW)

(21) Appl. No.: 15/073,678

(22) Filed: Mar. 18, 2016

(51) Int. Cl. G06Q 10/08; G05B 15/02; G05D 1/02

(52) U.S. Cl. CPC G06Q 10/08; G05D 1/0287; G05B 15/02

(57) ABSTRACT

A method of operating an order processing system using a plurality of automated or guided vehicles includes the following process. Data including information as to a floor plan of a storage space of a storage facility is imported through an input unit. A processor upon receiving purchasing requests defining the storage space into a plurality of loading zones based on the purchasing requests received and the number of automated vehicles deployed. The processor then assigns one automated vehicle to operate in a loading zone for picking articles and determines the processing sequence of the purchasing requests. The processor next generates a routing plan for controlling the loading operations of the automated vehicles according to the purchasing requests, the optimal processing sequence, and the floor plan data.

### CROSS-REFERENCE TO RELATED APPLICATIONS

This application claims priority to a U.S. Provisional Patent Application No. 62/112,177 filed on Feb. 2, 2015, the contents of which are incorporated by reference herein.

### FIELD

The subject matter herein generally relates to an automated or guided vehicles, particularly to a method and a system for deploying automated vehicle.

### BACKGROUND

Warehouses are essential components of any supply chain. Warehousing involves activities related to the movement of goods, including order receiving, storage, order picking, accumulation, sorting, and shipping within warehouses or distribution centers. Among the activities listed, order picking is the most intensive and costly process because its operations are labor-intensive and repetitive. Order picking is a process in which items ordered by customers are searched for, selected, and shipped from the warehouse to the customers. The order picking process plays important roles in the chain of the logistics operation, and affects the overall logistics operation of the warehouse. The order picking process not only has to meet all customer requirements including the required items, quantities demanded, and the associated due date but at same time be subject to the warehouse operational requirements, such as the operational hour of the warehouse facility and the operation cost. Thus, effectively utilizing the available resources in the warehouse and efficiently planning order picking process becomes an important issue.

### BRIEF DESCRIPTION OF THE DRAWINGS

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure.

FIG. 1A is a diagram illustrating an order processing system provided in accordance with an exemplary embodiment of the present disclosure.

FIG. 1B is a diagram illustrating an order processing system provided in accordance with another exemplary embodiment of the present disclosure.

FIG. 1C is a diagram illustrating an order report for the order processing system provided in accordance with an exemplary embodiment of the present disclosure.

FIG. 2 is a schematic diagram illustrating a layout of a warehouse facility provided in accordance to an exemplary embodiment of the present disclosure.

FIG. 3 is a block diagram illustrating an order processing and scheduling device provided in accordance to an exemplary embodiment of the present disclosure.

FIG. 4A˜FIG. 4B are diagrams illustrating a zoning operation of a storage facility provided in accordance to an exemplary embodiment of the present disclosure.

FIG. 5A˜FIG. 5B are diagrams illustrating a zoning operation of a storage facility provided in accordance to another exemplary embodiment of the present disclosure.

FIG. 6 is a diagram illustrating a zoning operation of a storage facility provided in accordance to another exemplary embodiment of the present disclosure.

FIG. 7 is a flowchart of a method for operating an order processing system applied in a storage facility provided in accordance to an exemplary embodiment of the present disclosure.

FIG. 8 is a flowchart of a routing solution generation method in a storage facility provided in accordance to an exemplary embodiment of the present disclosure.

FIGS. 9A˜9D are schematic diagrams illustrating an exemplary application interface for order processing and scheduling in a storage facility provided in accordance to an exemplary embodiment of the present disclosure.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

The term “coupled” is defined as connected, whether directly or indirectly through intervening components, and is not necessarily limited to physical connections. The term “comprising” is defined as “including, but is not necessarily limited to”; it specifically indicates open-ended inclusion or membership in a so-described combination, group, series and the like.

The present disclosure is described in relation to an order processing system using automated guided vehicles and a method for operating such order processing system. The order processing system is configured to support the operation of at least one storage facility, such as a logistics center, a warehouse facility, or a mailroom facility. The order processing system is operable to generate an optimal order picking and scheduling plan, effectively minimizing order processing time and operational cost. Particularly, the order processing system utilizes one or more automatic guided vehicles in coordination with the utilization of a computational intelligent algorithm to serve customer orders and pick up articles (e.g., goods or products) from the storage facility environment.

Automated guided vehicles (AGVs) are battery-powered, cell-driven vehicles used to transport articles, materials and other items from one location to another without any accompanying operator in a manufacturing facility or a warehouse facility. An AGV can follow at least one guiding path and be routed between stations along the guiding path. The guiding path may be sensed by the automated guided vehicle through electromagnetic, optical (e.g., laser), or other electrical systems. The loads transported by the automated guided vehicles may vary in size and depend upon the loading capacity of the automated guided vehicles. An AGV may also be called a laser guided vehicle (LGV). Lower cost versions of AGVs are often called Automated Guided Carts (AGCs) and are usually guided by magnetic tape. AGCs are available in a variety of models and can be used to move products on an assembly line, transport goods throughout a plant or warehouse, and deliver loads.

The present disclosure relates to an operation of the order processing system. Information regarding the hardware architecture of AGVs, the basic operations of the AGVs such as the guiding and routing method, as well as the movement control operations, are known in the art. Hence detailed explanations are omitted, only new information concerning the present disclosure will be provided in the present disclosure.

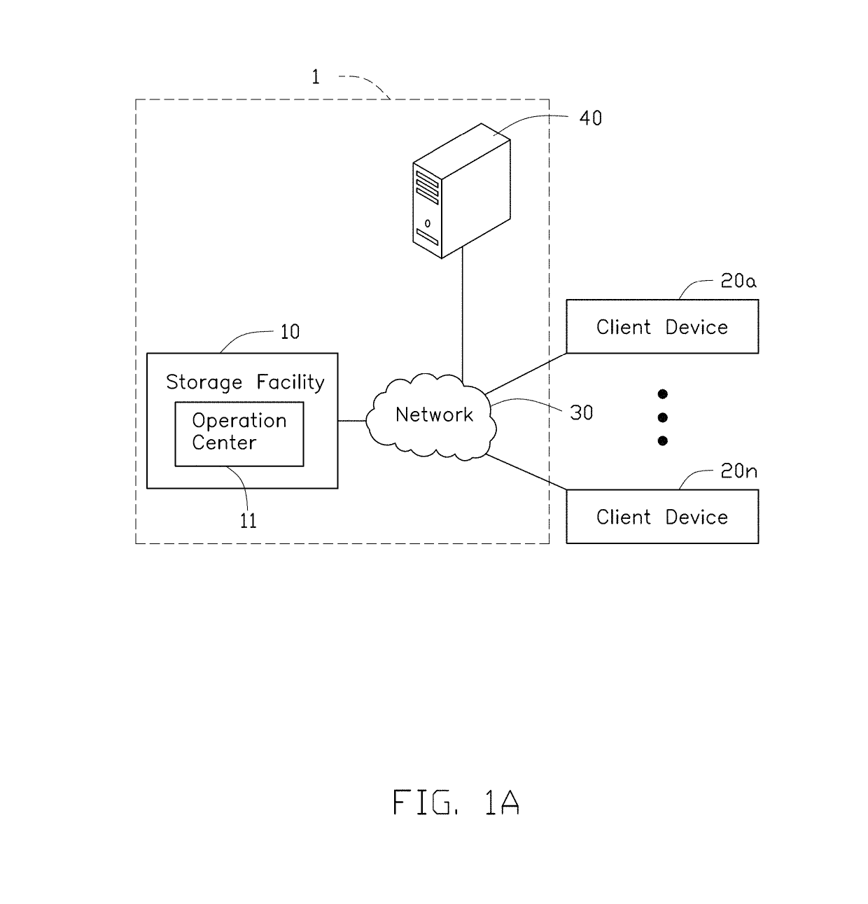

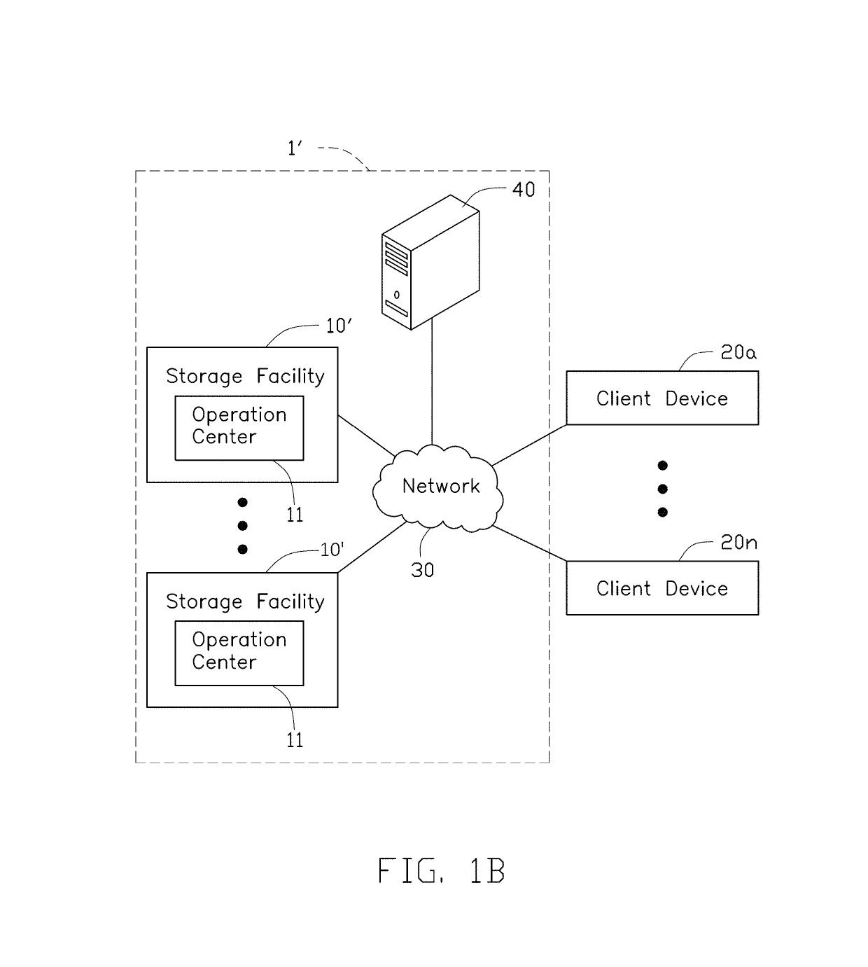

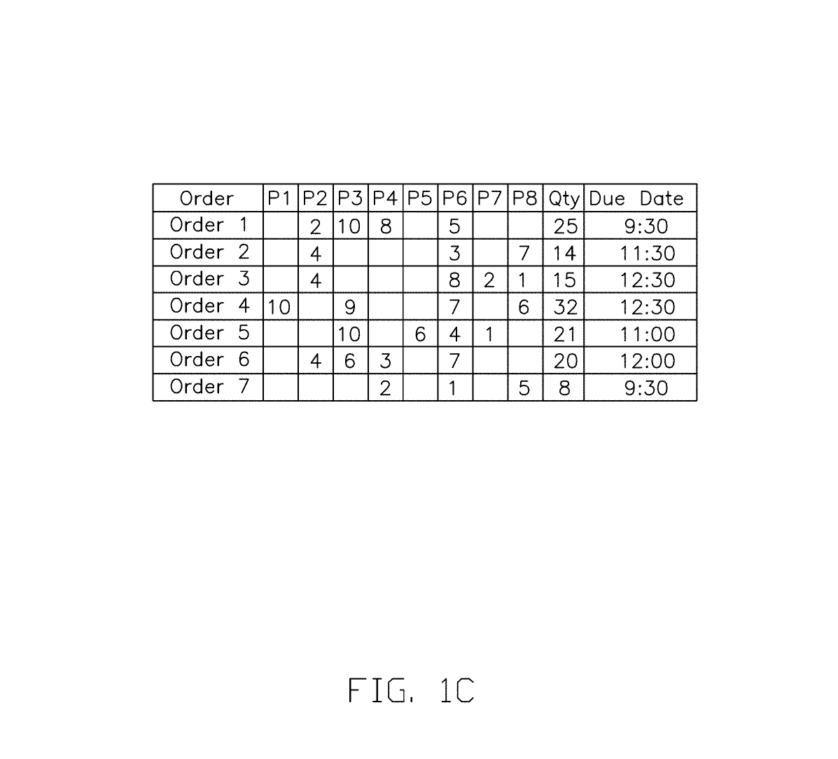

FIG. 1A shows an order processing system provided in accordance to an exemplary embodiment of the present disclosure. In the instant embodiment, an order processing system 1 incorporates cloud computing technologies. The order processing system 1 includes a storage facility 10 (e.g., a warehouse facility) and a cloud computing server 40. The storage facility 10 has an operation center (operation center 11) which is communicatively coupled to the cloud computing server 40 via a network 30. The order processing system 1 is communicatively coupled to a plurality of client devices 20a˜20n through the network 30 and can receive a plurality of purchasing requests from the client devices 20a˜20n.

In the instant embodiment, each of client devices 20a˜20n is operable to send a purchasing request to the cloud computing server 40 via the network 30. The cloud computing server 40 forwards the purchasing request to the storage facility 10 via the network 30 upon receiving the purchasing request. In some embodiments, each of client devices 20a˜20n may send the purchasing request directly to the operation center 11 of the storage facility 10 via the network 30.

The purchasing request includes at least an article information and a due date information. The article ordering information may refer to information that identifies the articles (e.g., goods, material or commodity products) placed on the order and the associated quantity demanded by a user (consumer) of the client device (e.g., the client devices 20a˜20n). The due date information herein represents the date that by which processing of the purchasing order by the storage facility 10 must be finished. In one embodiment, the due date information may be calculated based on a shipping date entered by the consumer using a client device (e.g., client devices 20a˜20n). In another embodiment, the due date information may be directly entered by the consumer.

Each client device 20a˜20n can generate the purchasing request based on a user operation, e.g., placing at least one order on a website supported by the storage facility 10. Each purchasing request at least includes an article ordering information and a due date information.

Each client device 20a˜20n may include, but is not limited to a smartphone, a PDA, a laptop, tablet, or any other equivalent computing device capable of providing at least the purchasing request. In some embodiments, the client devices 20a˜20n may send the purchasing request along with the location of that client device.

An application program may be installed on each of the client devices 20a˜20n and the application program enables each of the client devices 20a˜20n to communicate with the order processing system 1 and place orders, accordingly. In at least one embodiment, each client device (e.g., the client devices 20a˜20n) may download the codes or instructions associated with the application program from the cloud computing server 40 via the network 30. In another embodiment, the application program may be built-in in the client devices 20a˜20n.

In another embodiment, as illustrated in FIG. 1B, the order processing system 1′ may include a plurality of storage facilities 10′ (e.g., multiple warehouse facilities) and a cloud computing server 40. The storage facilities 10′ are communicatively coupled to the cloud computing server 40 through the network 30. Each client device 20a˜20n may send a purchasing request to the cloud computing server 40, and the cloud computing server 40 then forwards the purchasing request to the corresponding storage facility 10′ via the network 30 for the corresponding storage facility 10 to process the purchasing request.

FIG. 1C illustrates a scheduling report of purchasing requests. A typical order pick up system may either serve the purchasing request on a first come first served basis (e.g., serve sequentially from Order 1 to Order 7) or serve based on the earliest due date (e.g., serve Order 1 and Order 7 first, then serve Order 5). But neither method guarantees the finding of an optimal solution in terms of the operation of the storage facility 10 e.g., the processing time, the tolerable tardiness, or the operational cost.

The order processing system 1 of the instant embodiment generates an optimal order processing and scheduling plan taking considerations of all operational factors including the processing time, tolerable tardiness, and the operational cost.

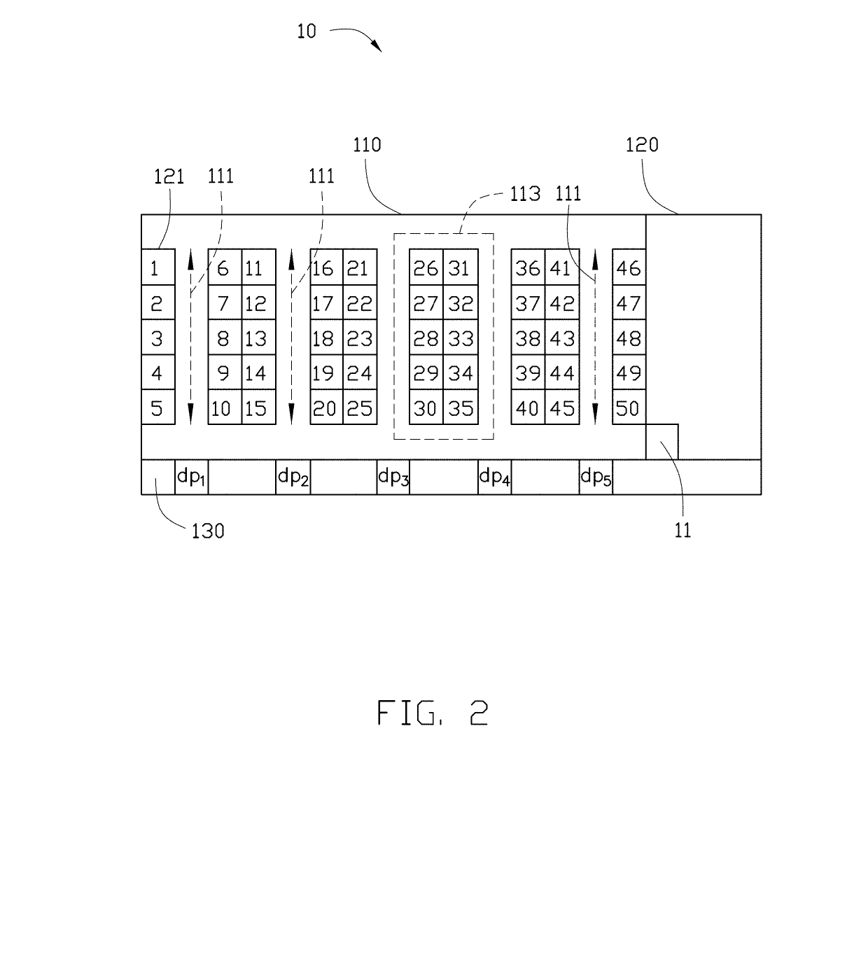

More specifically, the order processing system 1 is operable to control the order picking and processing operations for a warehouse facility illustrated in FIG. 2. The storage facility 10 in the instant embodiment includes the operation center 11, a storage space 110 (also called an order picking area), a packing area 120, and a transportation conveyor 130. The storage facility 10 is equipped with a plurality of AGVs for performing order picking and processing operations.

The storage space 110 is the place in the storage facility that stores articles. Articles herein may refer to raw material, goods, commodity products, and/or manufactured products, the present disclosure is not limited to the examples provided herein. The storage space 110 comprises a plurality of racks 121 with shelves numbered 1-50 for storing articles. The racks 121 are arranged in such manner that at least one guiding path 111,113 of sufficient width exists between adjacent racks for the assigned AGV to move along, performing article loading and picking operation. Each rack may store the same or different types of articles depends upon warehouse storage arrangement requirement.

Guiding paths, such as guiding paths 111 and 113 are shown in the drawings may exist between racks for the assigned AGVs to travel thereon. For example, the rack with shelves numbered 1-5 and the rack with shelves numbered 6-10 are served by the AGV traveling along the guiding path 111. Specifically, the AGV traveling along the guiding path 111 can pick articles from shelves numbered 1 to 10. Similarly, the AGV traveling along the guiding path 111 which is between the rack with shelves numbered 11˜15 and the rack with shelves numbered 16˜20, can pick articles from shelves 11-20. A guiding path allowing access to multiple racks forms a closed loop, e.g., the guiding path 113 as an example, and the AGV that travels along the guiding path 113 can pick articles from shelves 21-40.

In some embodiments, each rack may have first and second longitudinal sides in horizontal direction and also two front faces. Each rack may comprise a plurality of rack rows arranged on top of each other for storing articles.

The transportation conveyor 130 is configured to bridge between the storage space 110 and the packing area 120. The transportation conveyor 130 is configured to transfer the articles picked from the storage space 110 to the packing area 120 for order packing and shipping operations. The transportation conveyor 130 comprises a number of disposing positions dp1-dp5 corresponding to each guiding path for the AGV to place the articles picked from racks 121 and to transfer the articles to the packing area 120 for subsequent packing process.

In some embodiment, the storage facility 10 may only include the operation center 11, a storage space 110, and a packing area 120 and does not include the transportation conveyor 130. The AGVs for the storage facility functioning without the transportation conveyor are routed optimally to pick up articles from the corresponding shelves and deliver the articles directly to the packing area 120.

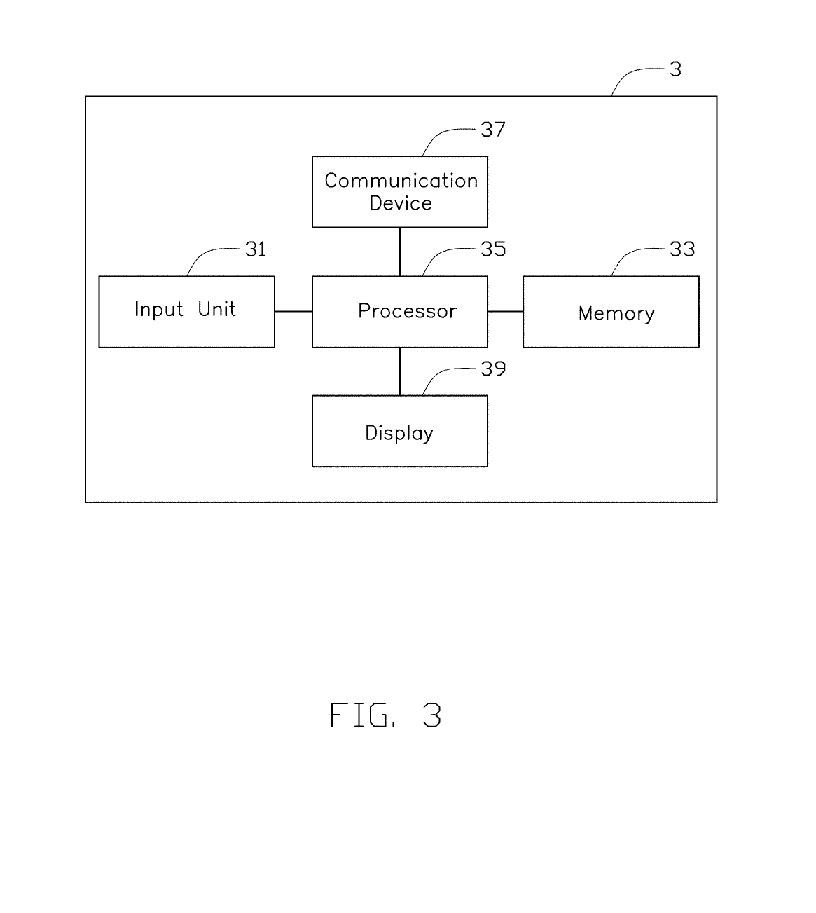

FIG. 3 shows an order processing and scheduling device provided in accordance to an exemplary embodiment of the present disclosure. An order processing and scheduling device 3 is configured to receive purchasing requests and to collect logistics information of the storage facility 10 including at least a floor plan data of the storage facility 10 and the storage of articles, and the AGV information. The order processing and scheduling device 3 can generate a routing plan for scheduling the article picking process. In one embodiment, the order processing and scheduling device 3 can be integrated with the operation center 11. In another embodiment, the order processing and scheduling device 3 may also be integrated in the cloud computing server 40 and may regulate the logistics operation of one or more storage facilities. In still another embodiment, the order processing and scheduling device 3 may be integrated with a control unit of the AGV).

The order processing and scheduling device 3 is configured to provide an application interface for an operator to enter order processing data. The order processing and scheduling device 3 is configured to generate a routing plan associated with the deployment of AGVs in the storage facility 10.

The order processing and scheduling device 3 includes an input unit 31, a memory 33, a processor 35, a communication device 37, and a display 39. The processor 35 is communicatively coupled to the input unit 31, the memory 33, the communication device 37, and the display 39.

The input unit 31 is configured for a user to import floor plan data of the storage facility 10, particularly, the floor plan data of the storage space 110 in the storage facility 10, through file uploading or data entry. The floor plan data may contain the number of racks in the storage space 110, the x- and y-coordinates data corresponding to positions of the racks, and the x- and y-coordinates data corresponding to positions of shelves 1-50 (e.g., the x- and the y-coordinate data associated with the articles), and the distance between one shelf and another (e.g., the Euclidean distances between shelves). The input unit 31 is configured for the user to enter order processing and logistic parameters, such as the delivery time constraints, the maximum operation time, the maximum tolerable tardiness, and the number of AGVs deployed in the storage facility 10, the loading capacity of each AGV, and the battery power limitations associated with AGV. The input unit 31 may be implemented by a keyboard, a keypad, a touch interface, or an application interface.

The memory 33 is configured to receive and store the purchasing request, the floor plan data, the order processing and logistics parameters, and operational data of the order processing and scheduling device 3. The memory 33 in the instant embodiment may be implemented by a volatile or a non-volatile memory such as a flash memory, a read only memory, or a random access memory. The instant embodiment is not to be limited to these examples.

The processor 35 is an operational core of the order processing and scheduling device 3 and controls the order processing operations. The processor 35 is configured to execute programs, applications, or software associated with the order processing operation provided by the memory 33. The processor 35 is configured to dynamically define loading zones in the storage space of the storage facility 10, assign AGVs and drive the AGVs to pick up articles based on the purchasing requests, taking account of the loading capacities and the moving speeds of the AGVs. The processor 35 in the instant embodiment can be implemented by a processing chip such as a microcontroller or an embedded controller, programmed with necessary program code. The present disclosure is not to be limited thereto.

The communication device 37 is configured to communicate with the cloud computing server 40 and the client devices 20a˜20n via the network 30. The display 39 is configured to present visual representations of the order processing (e.g., a routing plan) of the processor 35 and the purchasing request information, for the user to view. The display 39 may be implemented as a touch panel, a liquid crystal display panel, or any other displaying apparatus capable of displaying text and/or graphical content to a user or an operator of the order processing and scheduling device 3.

More specifically, upon the order processing and scheduling device 3 receiving the purchasing requests sent by the cloud computing sever 40 or sent directly from the client devices 20a˜20n through the communication device 37, the processor 35 operatively defines the storage space 110 as a plurality of loading zones, based on the purchasing requests received and the available AGV in the warehouse 10. In particular, the processor 35 defines the storage space 110 into a plurality of loading zones based on the articles ordered, the quantities demanded, the number of AGV deployed in the storage facility 10, and their respective loading capacities and moving speeds. Each of the loading zones comprises at least one guiding path for the AGVs to move along. There is no overlapping area between each loading zone.

The processor 35 then assigns one AGV to operate in one of the loading zones defined for picking articles based on the loading capacity and the moving speed of the AGV. By assigning only one AGV to operate in one of loading zones defined, no collision will occur between any of the operated AGVs, and all the AGVs are efficiently used. The processor 35 further determines the processing sequence of the purchasing requests for generating a routing plan, for controlling the loading operations of the AGVs. Specifically, the processor 35 generates a routing plan (i.e., optimal routing and order-picking scheduling plan) according to the purchasing requests, the processing sequence, and the floor plan data, such that the routing plan satisfies at least one operational constraint e.g., one of the delivery time constraint for each purchasing requests, the maximum operation time, the maximum tolerable tardiness, and the number of AGVs deployed in the storage facility 10, the loading capacity of each AGV, and the battery power limitations associated with AGV, the cost constraint.

In at least one embodiment, the processor 35 generates the routing plan satisfying all the operation constraints inputted by the user via the input unit 31.

In some embodiments, the operational constraints such as the loading capacity, the maximum operation time, and the battery power limitation must be satisfied in generating the routing plan, while the delivery time constraints, the maximum operation time, and the maximum tolerable tardiness are optional based on the operational requirements, e.g., minimizing the tardiness, or maximize the utilization of operational time.

Afterwards, the processor 35 issues a routing command to AGVs to be deployed based on the routing plan, to cause the AGVs to operate in the assigned loading zones and pick designated articles. The AGVs, after receiving the routing command, travels along the guiding paths in the assigned loading zone, picks up stored articles listed in the purchasing requests in a timely and efficient manner, and places articles on the disposition positions dp1-dp5 of the transportation conveyor 130 for subsequent packing and shipping processes.

In some embodiments, the storage facility 10 may not have the transportation conveyor 130 for delivering the articles picked to the packing area 120. In such embodiments, the AGVs, after receiving the routing command, travels along the guiding paths 111, 113 in the assigned loading zone, picks up stored articles listed in the purchasing requests in a timely and efficient manner, and deliver to a designated location of the packing area 120 for subsequent packing and shipping processes.

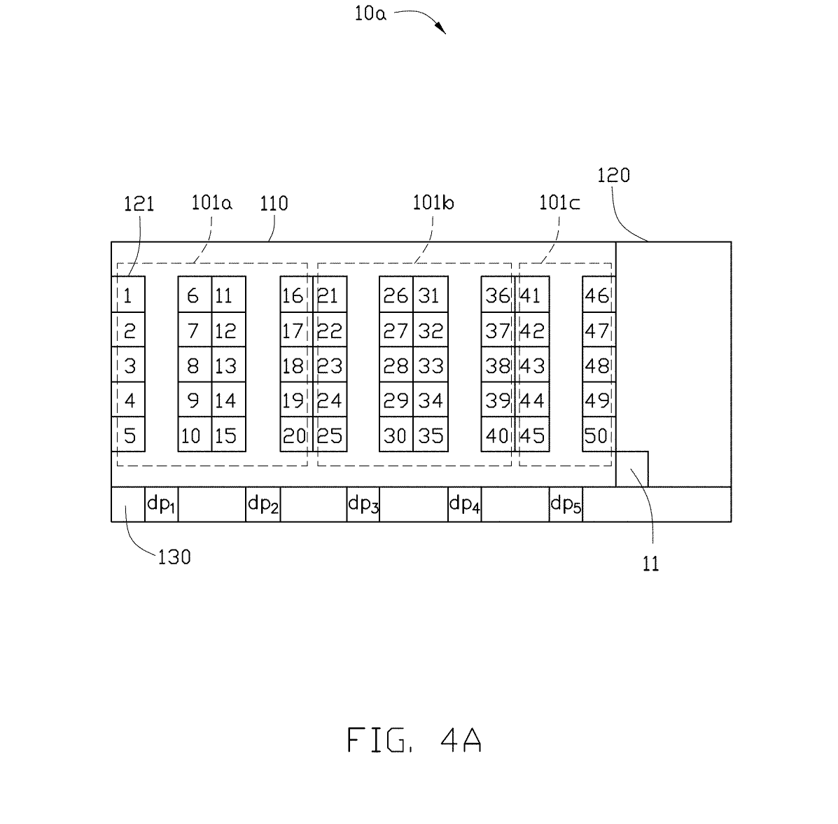

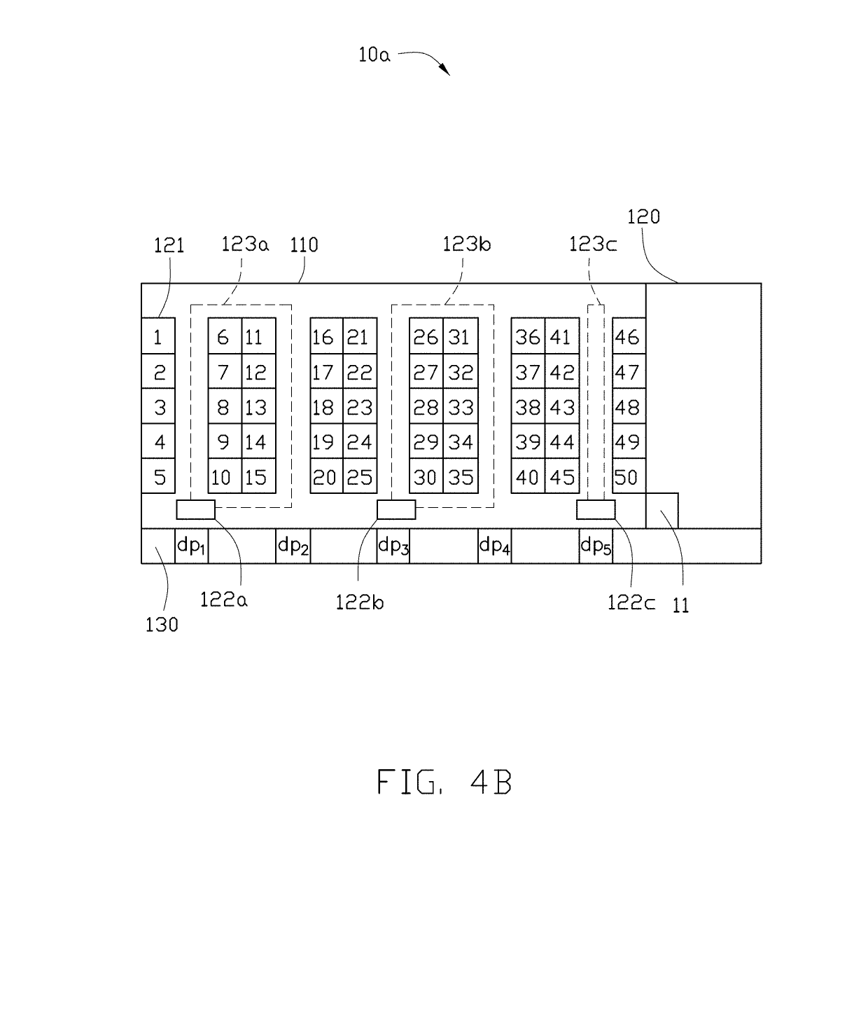

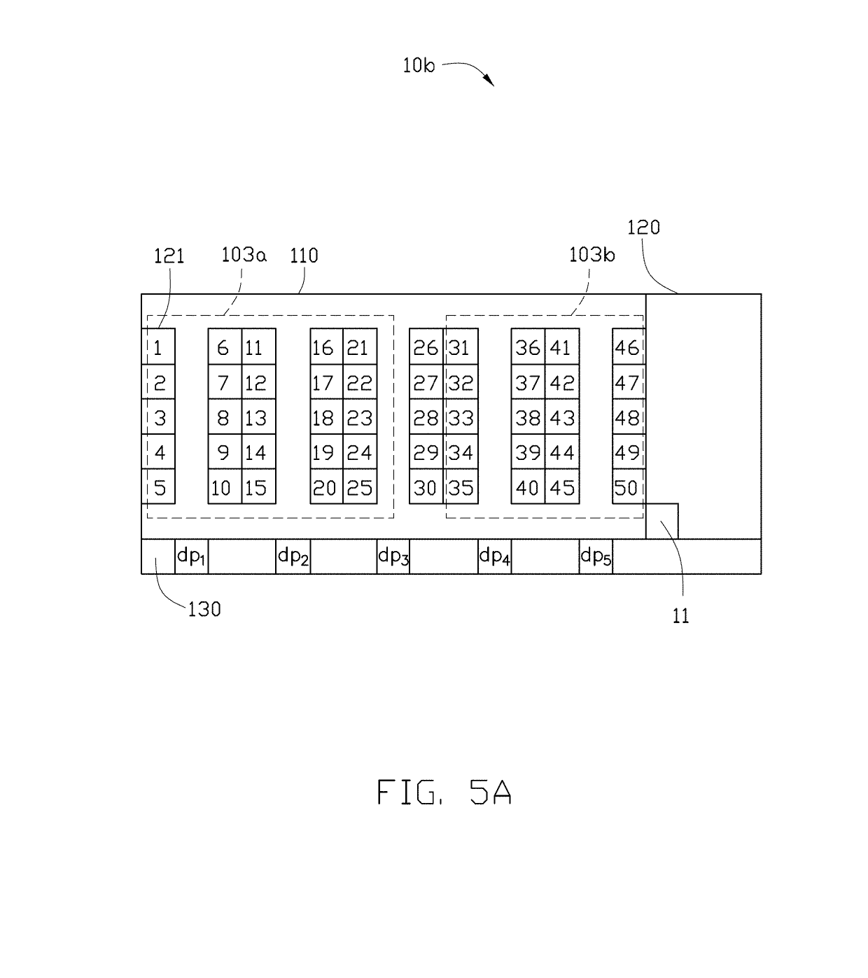

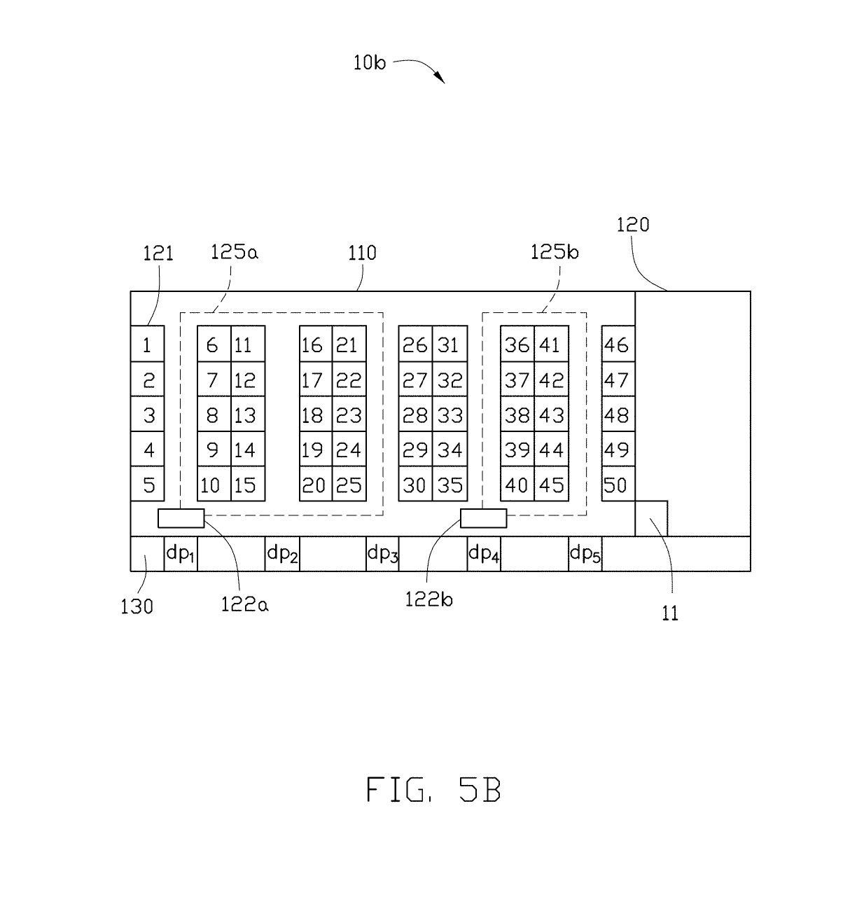

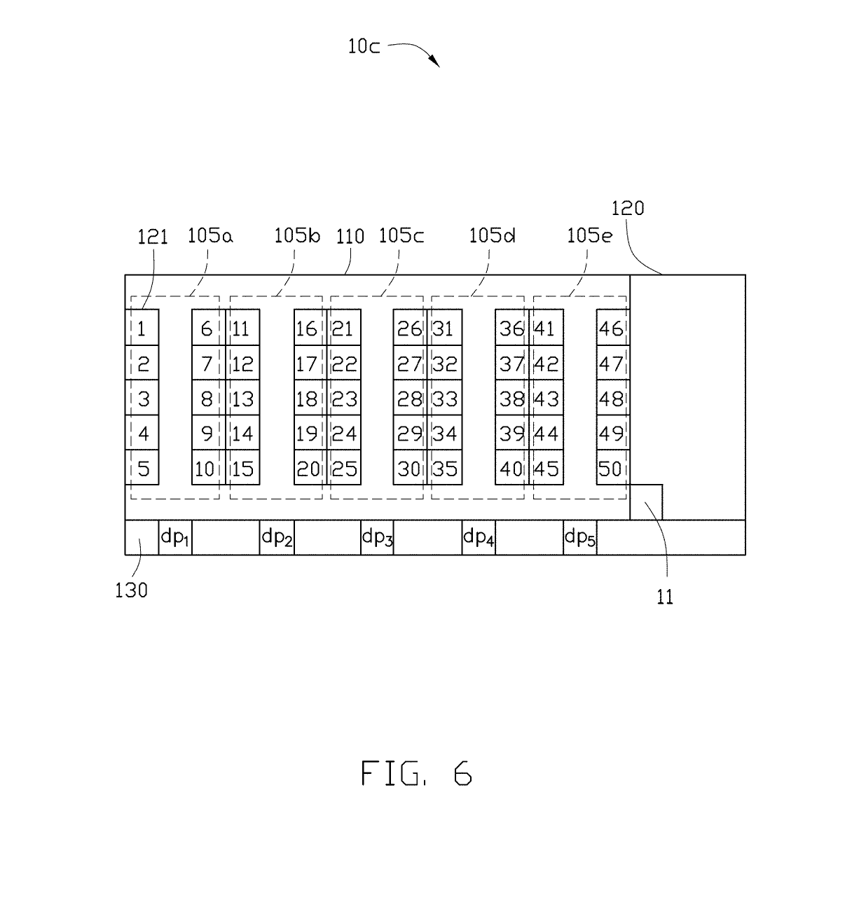

In some embodiments, FIG. 4A and FIG. 4B show a zone operation for the storage space 110 of a storage facility 10a provided in accordance to an embodiment of the present disclosure. The processor 35 defines the storage space 110 into three loading zones 101a, 101b, and 101c based on the purchasing requests and the available AGVs (e.g., three AGVs) deployed in the storage facility 10a. The size of each loading zone 101a, 101b, or 101c is defined by number of racks encompassed. In one embodiment, the size of loading zone where the concentration of articles demanded is high is smaller than the size of the loading zone where the concentration of articles demanded is lower. The processor 35 further assigns the three AGVs 122a, 122b, 122c to the loading zones 101a, 101b, and 101c based on the loading capacities of the AGVs and the purchasing requests.

The AGV 122a is configured to operate in the loading zone 101a and travel along guiding path 123a. The AGV 122a picks articles stored in shelves 1-20. The AGV 122b is configured to operate in the loading zone 101b and travel along the guiding path 123b. The AGV 122b picks articles stored in shelves 21-40. The AGV 122c is configured to operate in the loading zone 101c and travel along the guiding path 123b. The AGV 122c picks articles stored in shelves 41-50.

In one embodiment, an AGV with high loading capacity will be assigned to operate in a loading zone where the concentration of articles demanded is highest, and the AGV having lower loading capacity will be assigned to operate in a loading zone where the concentration of articles demanded is less.

FIG. 5A and FIG. 5B show a zone operation for the storage space 110 of a storage facility 10a provided in accordance to another embodiment of the present disclosure. In another embodiment, as illustrated in FIGS. 5A and 5B, the processor 35 defines the storage space 110 of a storage facility 10b into only two loading zones because the storage facility 10b only has two AGVs 122a and 122b. The AGV 122a is configured to operate in the loading zone 103a and travel along guiding path 125a. The AGV 122a picks up articles stored in shelves 1-30. The AGV 122b is configured to operate in the loading zone 103b and travel along the guiding path 123b. The AGV 122b picks up articles stored in shelves 31-50. FIG. 5B shows another zoning operation for the storage space 110 of a storage facility 10a provided in accordance to another embodiment of the present disclosure. When the order processing and scheduling device 3 receives purchasing requests containing a lot of articles to be picked from a storage facility 10c and the storage facility 10c has sufficient number of AGVs to deploy, the processor 35 may define the storage space 110 into number of loading zones based on the smallest size of loading zones, e.g., 5 loading zones 105a-105e. The processor 35 can subsequently assign five AGVs to the five loading zones defined.

The processor 35 of the order processing and scheduling device 3 is operable to generate the optimal order processing and scheduling plan to route the AGVs in a storage facility while picking up the article and quantity required, the delivery time constraint, and number of the AGVs, while taking the loading capacities of the AGVs deployed into consideration, thereby reducing the operational cost while enhancing the overall operational efficiency of the storage facility.

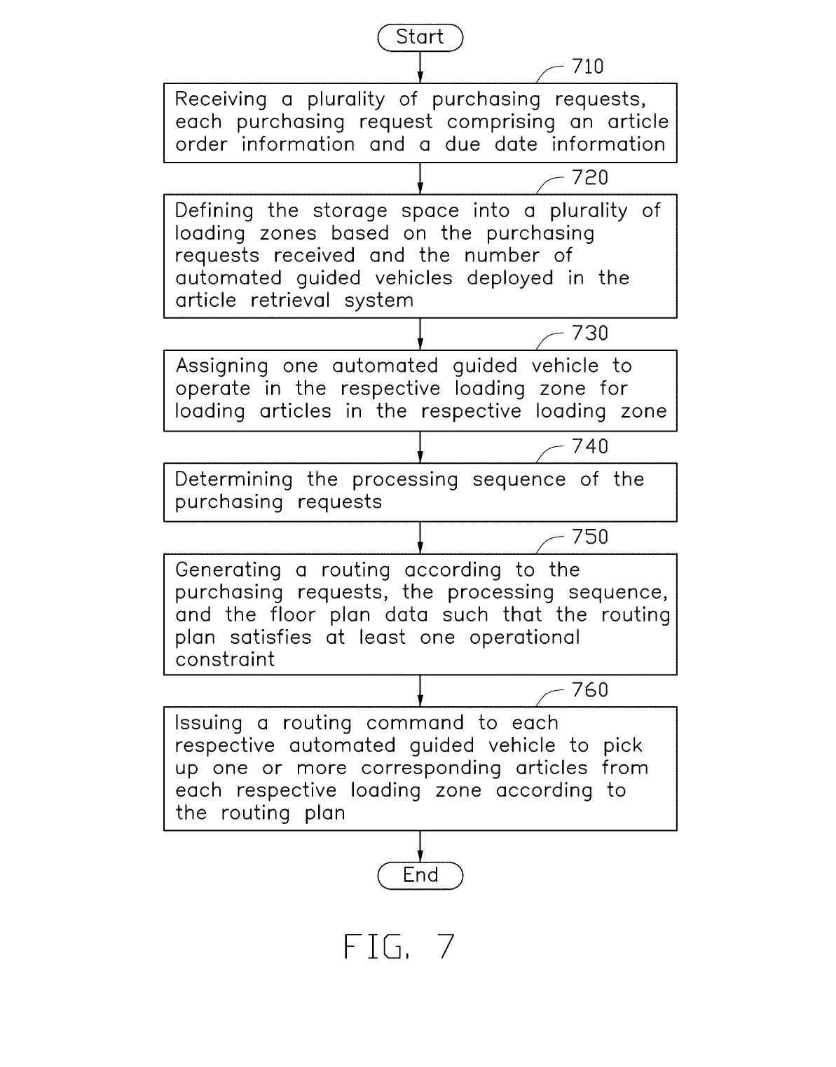

An embodiment of a method for operating an order processing system is also presented. The order processing system comprises a plurality of AGV operating in a storage space storing a plurality of articles, as illustrated in aforementioned embodiment. FIG. 7, in conjunction with FIG. 3, show a flowchart illustrating a method for operating an order processing system provided in accordance to an exemplary embodiment of the present disclosure. A floor plan data is imported into the order processing and scheduling device 3 through the input unit 31, the floor plan corresponds to the layout a storage space 110 of a storage facility, wherein the floor plan data at least comprises the locations of the articles. The articles may be goods, items, raw material, commodity products, and the like. The floor plan data may be stored in the memory 33.

A user or an operator of the order processing and scheduling device 3 may also pre-configure the operational parameters such as number of AGVs available in the warehouse, the hours of operation of the storage facility, the operational constraints including at least the delivery time constraint for each purchasing request, the maximum operation time, the maximum tolerable tardiness, the load capacities of the AGVs, and the cost constraint.

In block 710, the processor 35 receives a plurality of purchasing requests, wherein the purchasing requests can be generated and sent directly by the client devices (e.g., the client devices 20a˜20n) or from the cloud computing sever 40. Each purchasing request contains an article order information and a due date information, wherein the article order information can contain the article required and the quantities required.

In block 720, the processor 35 defines the storage space 110 of the storage facility into a plurality of loading zones based on the purchasing requests received and the number of AGVs deployed in the order processing system. More specifically, the processor 35 may define the loading zones by defining a number of racks forming each receptive loading zones, wherein each rack comprises a plurality of rack row arranged on top of each other for storing articles, and at least one guiding path between adjacent racks for the AGVs to move or travel along performing article loading operation.

In block 730, the processor 35 assigns one AGV to operate in one of the loading zones defined for picking up articles in the respective loading zone. Specifically, the processor 35 determines the loading capacity of each AGV and assigns the AGV to operate in the respective loading zone based on the loading capacity of each AGV and the size of the loading zone. The size of the loading zone is defined by the number of racks encompassed.

In block 740, the processor 35 determines the processing sequence of the purchasing requests. In block 750, the processor 35 generates a routing plan for controlling the loading operations of the AGVs according to the purchasing requests, the processing sequence, and the floor plan data such that the routing plan satisfies at least one operational constraint.

In some embodiments, the operational constraints considered in generating the routing plan comprises at least one delivery time constraint for each purchasing request and the cost constraint.

In some embodiment, the operational constraint considered in generating the routing plan may further comprise the maximum operation time, the maximum tolerable tardiness and a battery power constraint for each AGV.

In some embodiment, the processor 35 generates the routing plan using the traveling salesman problem (TSP) routing scheme or vehicle routing scheme for minimizing the traveling distance, henceforth the traveling time of the AGVs during the order picking process.

In some embodiments, the processor 35 generate the routing plan that satisfies all the operational constraints, i.e., the routing plan satisfies the loading capacity, the maximum operation time, and the battery power constraint for each AGV deployed, the delivery time constraints, the maximum operation time, and the maximum tolerable tardiness.

In some embodiments, the operational constraints such as the loading capacity, the maximum operation time, and the battery power limitation must be satisfied in generating the routing plan, while the delivery time constraint for each purchasing request, the maximum operation time, and the maximum tolerable tardiness are optional based on the operational requirements, e.g., minimizing the tardiness, or maximize the utilization of operational time.

In block 760, the processor 35 may further issue a routing command to each of the AGVs using the communication device 37 to pick up one or more corresponding articles from each respective loading zone according to the routing plan.

In some embodiments, the processor 35 may further issue a unload command to each AGV to unload one or more corresponding articles loaded from each respective loading zone onto the corresponding disposition position on the transportation conveyor 130, wherein the transportation conveyor 130 transfers the articles placed thereon to a packing area 120.

In some embodiment, the processor 35 may be configured to execute an optimization routing procedure to define the loading zones (block 720), the assignment of AGVs (block 730) the processing sequence of the purchasing request (block 750) for generating the optimal routing plan. The optimization routing procedure may be implemented using various optimization algorithm through mathematical modeling and includes but is not limited to a Genetic algorithm (GA), a Simulated Annealing (SA), a CHC generic algorithm, Evolution Strategy (ES), Ant Colony Optimization (ACO), GA+SA Hybrid Algorithm, Cooperative Local Search (CLS), Particle Swarm Optimization (PSO), or the equivalent.

The present disclosure further provides an exemplary implementation using SA algorithm as an illustration. The SA algorithm is a random search technique which exploits an analogy between the way in which a metal cools and freezes into a minimum energy crystalline structure (the annealing process). The SA algorithm is capable of generating optimal solution by avoiding trapped in local minima by employing random search only accepts changes that have better evaluation result generated from a pre-defined objective function ƒ, and subject to changes causing the worse solution with small probability.

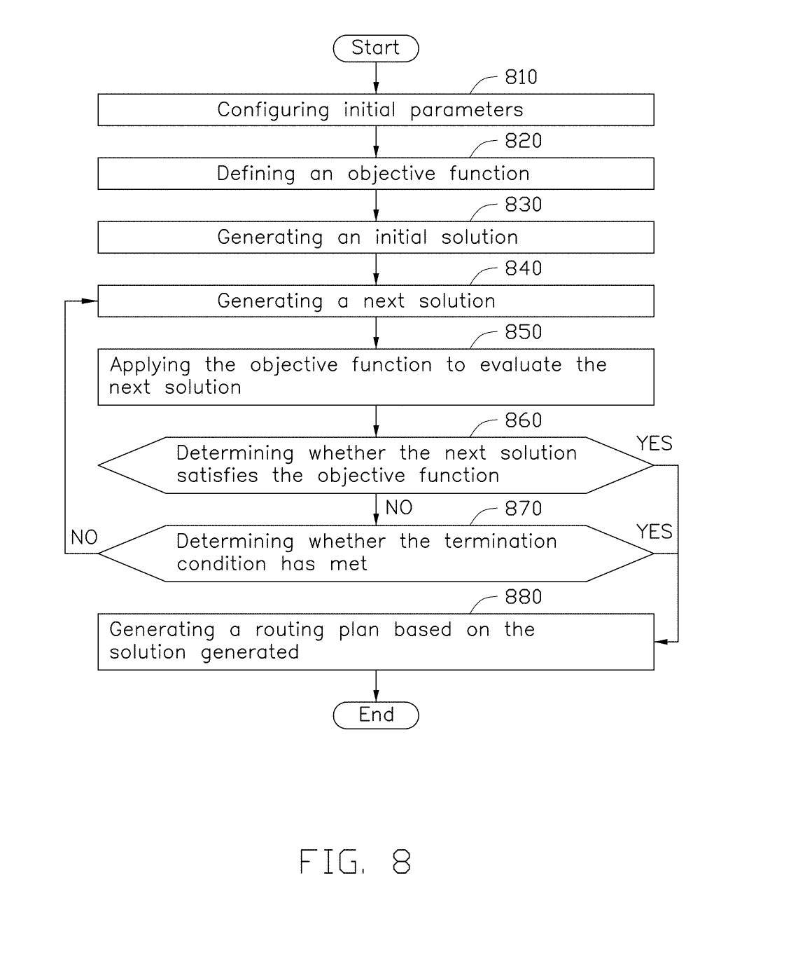

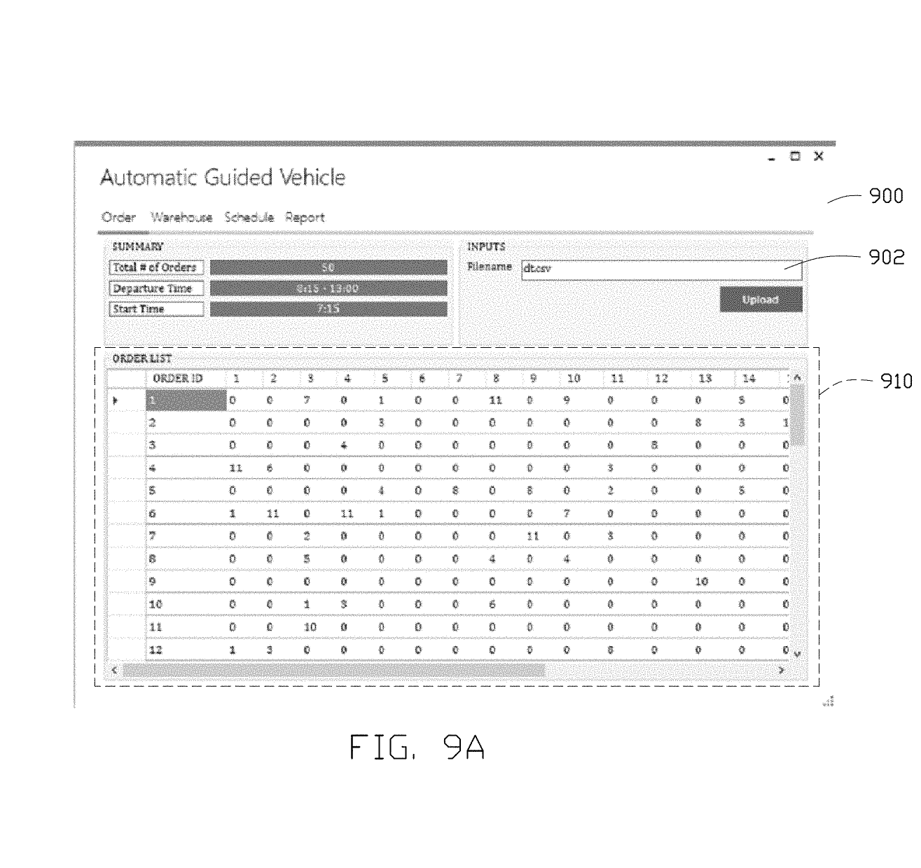

FIG. 8 shows a flowchart diagram illustrating a routing solution generation method provided in accordance to an exemplary embodiment of the present disclosure.

In block 810, the processor 35 configures initial parameters for implementing the SA algorithm. The initial parameters at least include an initial temperature, a final temperature, number of iterations, initial solution generation scheme (e.g., heuristic solution), and probabilities for generating next solution using swap, insert, or reverse scheme. The initial temperature, the final temperature, and the number of iterations determine the overall searching iterations for searching and obtaining optimal solutions. The initial parameters are pre-configured and are stored in the memory 33 for the processors to access.

In block 820, the processor 35 defines an objective function ƒ based on at least one of the delivery time constraint for each purchasing request, the maximum tardiness allowable for each purchasing request, the battery power constraint for each AGV, the operation time, the loading capacity of each AGV and the cost constraint. The delivery time constraint for each purchasing request, the battery power constraint for each AGV, the operation time, the loading capacity of each AGV, and the maximum tardiness may collective set order processing time constraint for generating the routing plan, while the cost constraint defines the overall logistic operation cost. The objective function ƒ is configured for evaluating each potential solution used for generating the routing plan so that the routing plan generated satisfies the operational constraints.

In block 830, the processor 35 generates an initial solution X based on the due date information of each purchasing requests. The initial solution X may in one embodiment generated based on the greedy heuristic e.g., first come first served basis or the earliest due date. The processor 35 computes the objective value of the initial solution X using the objective function ƒ defined to be obj (X, P), wherein P is the probability of accepting the initial solution X. The processor 35 set the initial solution X temporarily as the best solution and the objective value computed for the initial solution X as the objective baseline.

The processor 35 models the processing sequences of the purchasing requests, the loading zones, the pickup sequence of the articles, and the AGVs into arrays, which collectively form as a solution set. For instance, for 30 purchasing requests, and 50 articles to be picked from the warehouse (e.g., the storage facility 10 of FIG. 2) as an illustrative example, the initial solution X may be modeled as follow. The processing sequence for a first come first serve scheme may be modeled as an array of {1, 2, 3, 4, 5, 6, 7, 8, 9, 10, 11, 12, 13, 14, 15, 16, 17, 18, 19, 20, 21, 22, 23, 24, 25, 26, 27, 28, 29, 30}. The zoning operation may be modeled as an array of {1, 1, 0, 0, 1}, wherein, 1 represents an AGV has assigned, and 0 represents no AGV has assigned. More specifically, based on the zoning solution set, the processor 35 defines the storage space 110 into three loading zones. One AGV has been assigned to the first loading zone and responsible for picking articles from shelves 1-10. One AGV has been assigned to the second loading zone for picking articles from shelves 11-40. One AGV has been assigned to the third loading zone for picking articles from shelves 41-50. The routing decision modeling the article picking sequence for the three AGVs may be modeled as an array of {5, 10, 4, 9, 3, 8, 2, 7, 1, 6}, an array of {11, 16, 12, 17, 13, 18, 14, 19, 15, 20, 25, 30, 24, 29, 23, 28, 22, 27, 21, 26, 36, 32, 37, 33, 38, 39, 45, 40}, and an array of {45, 50, 44, 49, 43, 48, 42, 47, 41, 46}, respectively.

In block 840, the processor 35 generates a next solution Y based on the initial solution X. Specifically, the processor 35 uses the swap operation, the insertion operation, and the reverse operation to generate the next solution Y. In the swap operation, the processor 35 randomly a node is picked randomly from one array index and swapping position with random node from another array index. For instance, the processing sequence array may be changed into {1, 2, 3, 4, 5, 6, 7, 13, 9, 10, 11, 12, 8, 14, 15, 16, 17, 18, 19, 20, 21, 22, 23, 24, 25, 26, 27, 28, 29, 30} after perform swap operation for 8^{th} element and 13^{th} element. In the insertion operation, the processor 35 selects a node randomly from one array index and inserted to other array index. For instance, the processing sequence array may be changed into {1, 2, 3, 4, 5, 6, 14, 7, 8, 9, 10, 11, 12, 13, 15, 16, 17, 18, 19, 20, 21, 22, 23, 24, 25, 26, 27, 28, 29, 30} after inserting the 14^{th} element before the 7^{th} element. In the reverse operation, two array indices are selected randomly then reverse the sequence of node in between selected array index. For instance, the processing sequence array may be changed into {1, 2, 3, 4, 5, 6, 7, 13, 9, 12, 11, 10, 8, 14, 15, 16, 17, 18, 19, 20, 21, 22, 23, 24, 25, 26, 27, 28, 29, 30}.

In some embodiment, the processor 35 may generate the next solution Y using random change scheme, i.e., the processor 35 randomly selects an array index of loading zones set and randomly changed by maintain the feasibility of the zoning decision. When the modification to the loading zones assignment has changed (e.g., the zoning operation model array has changed), the processor 35 may correspondingly modify the array modeled for the routing sequence.

In block 850, the processor 35 evaluates the next solution Y using the objective function ƒ to generate the objective value obj (Y, P) for the next solution Y.

In block 860, the processor 35 determines whether the next solution Y satisfies the objective function (e.g., satisfies the operational constraint including the delivery time constraint for each purchasing request and the cost constraint) based on the evaluation result. If the next solution does improve the best solution in consecutive temperature iterations, then the next solution does not satisfy the objective function, executes block 870. If the next solution doesn't improves the best solution in consecutive temperature iterations, then the next solution satisfies the objective function for each purchasing request and the cost constraint, the processor 35 executes block 880.

In block 880, the processor 35 generates the routing plan based on the solution generated.

In block 870, the processor 35 determines that whether the termination condition has met, i.e., whether the current temperature reaches the final temperature. If the termination condition has not met, decreases the current temperature, and repeats block 840 through block 860 until the solution generated satisfies at least one of operational constraints (e.g., the delivery time constraints, the maximum operation time, the maximum tolerable tardiness, and the number of AGVs deployed in the storage facility 10, the loading capacity of each AGV, and the battery power limitations associated with each AGV) or the termination condition has met. If termination condition has met, executes block 880 and generates the routing plan.

In some embodiments, after the processor 35 determines that the termination condition has met, the processor 35 may further perform another local search of the solution by performing at least one of the swap operation, the insertion operation, and the reverse operation to generate a last solution and evaluate the last solution with the objective function to verify whether the objective value of the last solution is better (e.g., the objective value is larger) than the final solution obtained before the termination condition has met. If the last solution from the local search is determined better than the final solution obtained before the termination condition has met, the processor 35 generates the routing plan based on the last solution found form the local search.

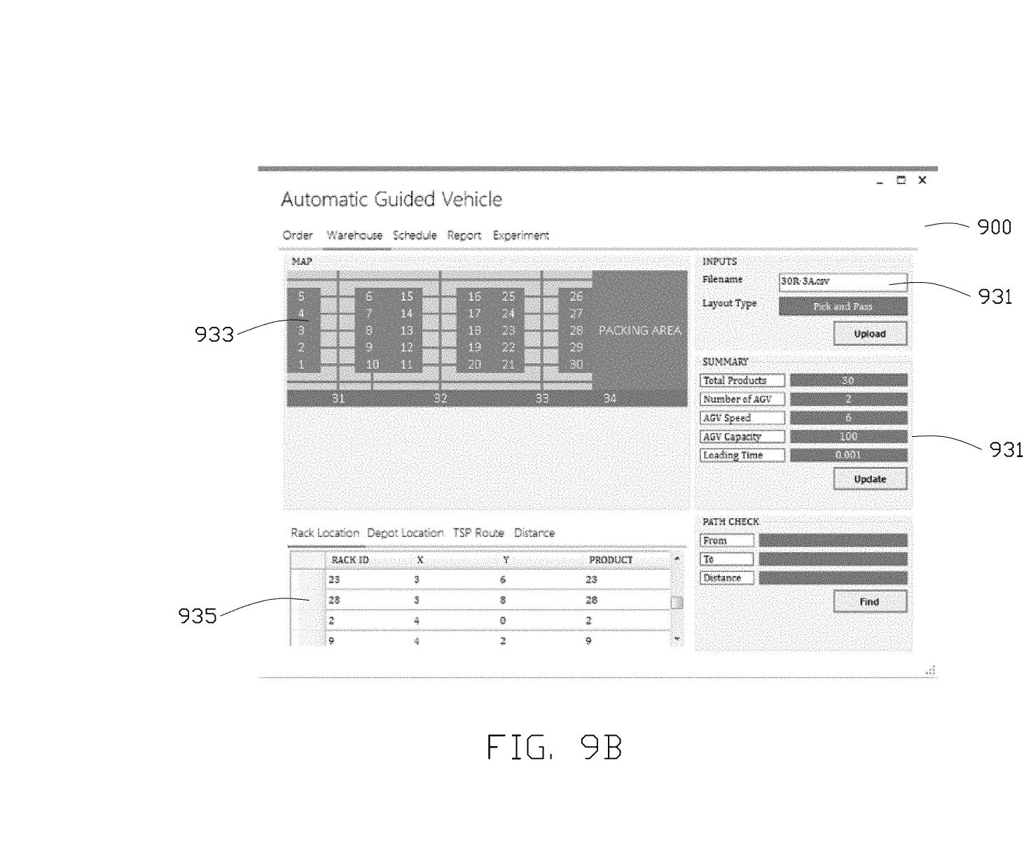

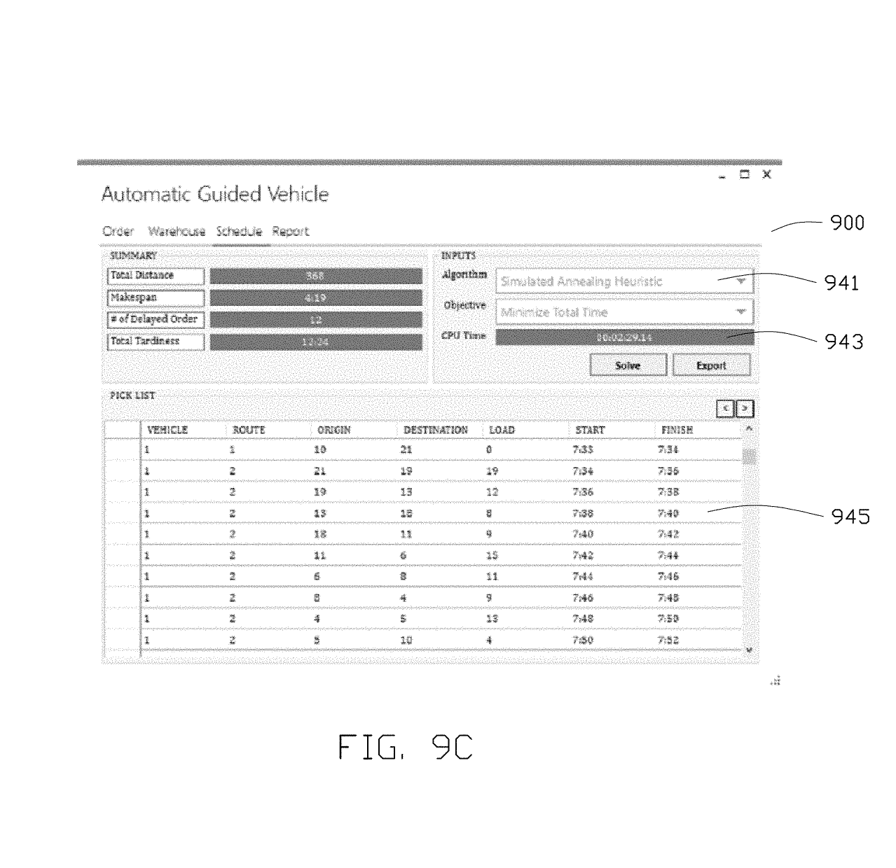

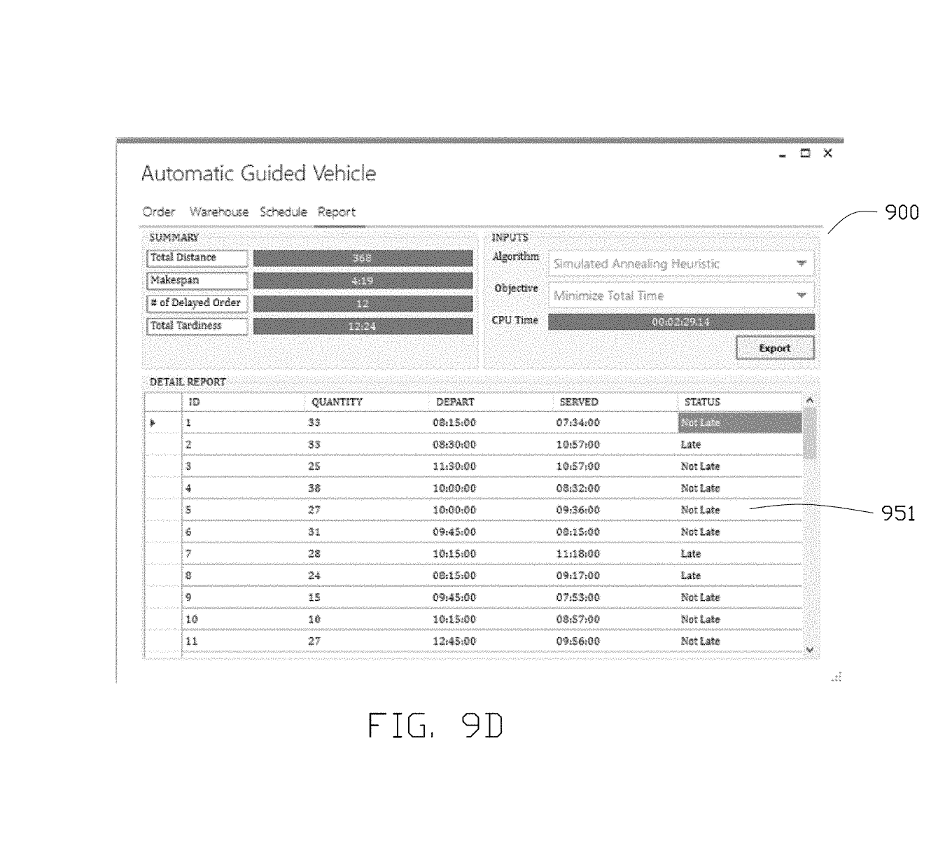

FIG. 9A˜FIG. 9D illustrate an exemplary application interface 900 for the aforementioned order processing and scheduling device 3 provided in accordance to an exemplary embodiment of the present disclosure.

FIG. 9A provides an interface for the user or the operator of the order processing and scheduling device 3 to import or upload the purchasing request file in an upload field 902 for inputting the article order information and view the purchasing requests in a list form in a window 910.

FIG. 9B provides an interface for the user or the operator to upload the floor plan data file for the storage facility to be monitored and managed. The floor plan data file can be upload in a field 931 and displayed in a window 933. The user or the operator may view and update logistic information and the status of the AGVs in a summary window 935 or check guiding path traveled by the AGV in a path check 937. Accordingly the order-picking process can be detailed monitored and the overall efficiency can be enhanced

FIG. 9C and FIG. 9D provide an interface for the user or the operator to select an optimization algorithm, such as simulated Annealing (SA) Algorithm or Generic Algorithm (GA) in an algorithm field 941 and the objective in field 943 (e.g., time minimization, minimize tardiness, cost minimization). The routing plan is generated and displayed in a window 945 and a window 951 for the user or operator to view and determined whether to execute.

FIG. 9A˜FIG. 9D illustrate exemplary application interfaces applicable for the order processing and scheduling device 3, therefore shall not be used to limited the scope of present disclosure.

In comparison to prior technology, the method and system for regulating the order picking operation of one or more storage facilities deploying AGVs e.g., warehouse, enable the operator to efficiently generate an order-picking plan through dynamically defining loading zone, assigning corresponding AGVs, smart routing the AGVs in order picking operation based on the ordering information, the due date information, the loading capacity, and the moving capacity of the automated guiding vehicle. Accordingly, not only the overall logistic operation efficiency can be enhanced, the order picking process can be detailed monitored as well.

Additionally, the present disclosure also discloses a non-transitory computer-readable media for storing the computer executable program codes of the order processing and scheduling method for operating an order processing system depicted in FIG. 7, and the optimization method depicted in FIG. 8. When the non-transitory computer readable recording medium is read by a processor, the processor executes the aforementioned order processing and scheduling method and the optimization method. The non-transitory computer-readable media may be a floppy disk, a hard disk, a compact disk (CD), a flash drive, a magnetic tape, accessible online storage database or any type of storage media having similar functionality known to those skilled in the art.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. A method of operating an order processing system that comprises a plurality of automated guided vehicles operating in a storage space storing a plurality of articles, the method comprising:
importing, by an input unit, a floor plan data of the storage space, wherein the floor plan data comprises a location data of the articles;
receiving, by a processor, a plurality of purchasing requests, each purchasing request comprising article order information and a due date information;
defining, by the processor, the storage space into a plurality of loading zones based on the purchasing requests received and the number of the automated guided vehicles deployed in the order processing system, wherein each loading zone comprises at least one guiding path for the automated guided vehicles to move along;
assigning, by the processor, one automated guided vehicles to each of the loading zones defined for picking up the articles required in the respective loading zone;
determining, by the processor, the processing sequence of the purchasing requests; and
generating, by the processor, a routing plan for controlling loading operations of the automated guided vehicles according to the purchasing requests, the processing sequence, and the floor plan data such that the routing plan satisfies at least one constraint, the constraint comprising at least one delivery time constraint for each purchasing request and a cost constraint.

2. The method according to claim 1, further comprising
issuing, by the processor, a routing command to the respective automated guided vehicles to pick up one or more corresponding articles from the assigned loading zone according to the routing plan.

3. The method according to claim 1, further comprising:
causing, by the processor, each of the automated guided vehicles to unload one or more corresponding articles picked from each respective loading zone onto a transportation conveyor, wherein the transportation conveyor transfers the articles placed thereon to a packing area.

4. The method according to claim 1, wherein the storage space comprises a plurality of racks, and the process of defining the plurality loading zones in the storage space comprises:
defining a number of racks forming each receptive loading zones;
wherein each rack comprises a plurality of rack row arranged on top of each other for storing articles, and at least one guiding path between adjacent racks for the automated guided vehicles to move along performing article loading operation.

5. The method according to claim 4, wherein the process of assigning one automated guided vehicle to operate in the respective loading zone for loading articles in the respective loading zone comprises:
determining, by the processor, a loading capacity and a moving speed of each automated guided vehicle; and
assigning, by the processor, the automated guided vehicle to operate in the respective loading zone based on the loading capacity of each automated guided vehicle and the size of the loading zone, wherein the size of the loading zone is defined by the number of racks encompassed.

6. The method according to claim 1, wherein the processor executes the processes of defining the storage space into a plurality of loading zones, assigning loading zones to the automated guided vehicles, and the processing sequence of the purchasing request using a Simulated Annealing algorithm (SA).

7. The method according to claim 1, wherein the process of receiving the plurality of purchasing requests comprises:
receiving, by the processor, the purchasing requests from a plurality of client devices for acquiring the articles stored in the storage space.

8. The method according to claim 1, wherein the process of importing the floor plan data of the storage space comprises
importing, by the input unit, the floor plan data by importing a floor plan file associated with the storage space, wherein the floor plan file records the location data of the articles stored in the storage space, and the location data of each articles comprises x-coordinate data and y-coordinate data.

9. The method according to claim 1, further comprising
displaying, by a display unit, a visual representation of the routing plan.

10. An order processing system comprising:
a plurality of automated guided vehicles operable to load and unload articles stored in a storage space;
an input configured to accept input of a constraint information, a floor data plan, and a number of automated guided vehicles, wherein the floor plan data comprises a location data of the articles;
an order processing and scheduling device comprising:
a processor configured to operate the order processing system;
a computer readable medium coupled to the processor and configured to receive the constraint information, the floor data plan, and a number of the automated guided vehicles from the input unit, the computer readable medium further comprising instructions stored therein which, upon execution by the processor, causes the processor to perform operations comprising:
receiving a plurality of purchasing requests, each purchasing request comprising article order information and a due date information;
defining the storage space into a plurality of loading zones based on the purchasing requests received and the number of automated guided vehicles deployed in the order processing system, wherein each loading zone comprises at least one guiding path for the automated guided vehicles to move along;
assigning one automated guided vehicle to each of the loading zones defined for picking up articles in the respective loading zone;
determining the processing sequence of the purchasing requests; and
generating a routing plan for controlling the loading operations of the automated guided vehicles according to the purchasing requests, the processing sequence, and the floor plan data such that the routing plan satisfies at least one constraint, the constraint comprising at least one a delivery time constraint for each purchasing request and a cost constraint; and
a display unit, configured to display a visual representation of the routing plan.

11. The system of claim 10, wherein the processor is further configured to, upon execution of the instructions stored in the computer readable medium, issue a routing command to each respective automated guided vehicle to pick up one or more corresponding articles from each respective loading zone according to the routing plan.

12. The system of claim 10, wherein the storage space comprises a plurality of racks and the processor is further configured to, upon execution of the instructions stored in the computer readable medium, defines a number of racks forming each receptive loading zones, wherein each rack comprises a plurality of rack row arranged on top of each other for storing articles, and at least one guiding path between adjacent racks for the automated guided vehicles to move along performing article loading operation.

13. The system of claim 10, wherein the storage space comprises a plurality of racks and the processor is further configured to, upon execution of the instructions stored in the computer readable medium, determine a loading capacity and a moving speed of each automated guided vehicle, and assigned the automated guided vehicles to operate in the respective loading zones based on the loading capacity of each automated guided vehicle and the size of the loading zone, wherein the size of the loading zone is defined by the number of racks encompassed.

14. The system according to 10, further comprising a transportation conveyor for operatively transferring articles placed thereon to a packing area, and the processor configured to cause each of the automated guided vehicles to unload one or more corresponding articles picked from each respective loading zone onto the transportation conveyor.

15. The system according to 10, wherein each of the automated guided vehicle is an automated guided cart.

16. A method of operating an order processing system comprising a plurality of automated guided vehicles operating in a storage space storing a plurality of articles, and the method comprising:
importing, by an input unit, a floor plan data of a storage space, wherein the floor plan data comprises a location data of the articles;
receiving, by a processor, a plurality of purchasing requests, each purchasing request comprising an article order information and a due date information;
defining, by the processor, the storage space into a plurality of loading zones based on the purchasing requests received and the number of automated guided vehicles deployed in the order processing system, wherein each loading zone comprises at least one guiding path for the automated guided vehicles to move along;
assigning, by the processor, one automated guided vehicle to each of the loading zones defined for picking up articles in the respective loading zone;
determining, by the processor, the processing sequence of the purchasing requests;
generating, by the processor, a routing plan for controlling the loading operations of the automated guided vehicles according to the purchasing requests, the processing sequence, and the floor plan data; and
dispatching, by the processor, the automated guided vehicles in such as manner that each automated guided vehicle travels alone the guiding path in the assigned loading zone and picks corresponding articles listed in the purchasing requests stored in the assigned loading zone according the purchasing requests and the floor plan data.

17. The method according to claim 16, further comprising:
causing, by the processor, each of the automated guided vehicle to unload one or more corresponding articles loaded from each of the respective loading zones onto a transportation conveyor, wherein the transportation conveyor transfers the articles placed thereon to a packing area.

18. The method according to claim 16, wherein the storage space comprises a plurality of racks, and the process of defining the plurality loading zones in the storage space comprises:
defining a number of racks forming each receptive loading zones;
wherein each rack comprises a plurality of rack row arranged on top of each other for storing articles, and at least one guiding path between adjacent racks for the automated guided vehicles to move along performing article loading operation.

19. The method according to claim 16, wherein the process of assigning one automated guided vehicle to operate in the respective loading zone for loading articles in the respective loading zone comprises:
determining, by the processor, the loading capacity of each automated guided vehicle;
assigning, by the processor, the automated guided vehicle to operate in the respective loading zone based on the loading capacity of each automated guided vehicle and the size of the loading zone, wherein the size of the loading zone is defined by the number of racks encompassed.
